(19) United States
(12) Patent Application Publication
(10) Pub. No.: US 2011/0101273 A1
(43) Pub. Date: May 5, 2011

(54) Process and Composition for Making Rare Earth Doped Particles and Methods of Using Them

(76) Inventor: Robert Rewick, Mountain View, CA (US)

(21) Appl. No.: 12/965,704

(22) Filed: Dec. 10, 2010

Related U.S. Application Data
(63) Continuation of application No. 11/228,989, filed on Sep. 16, 2005, now abandoned.

(51) Int. Cl. C01F 17/00; C09K 11/85

(52) U.S. Cl. 252/301.4 H; 423/263

(57) ABSTRACT

Methods for synthesizing a phosphor which is capable of upconversion fluorescence. One exemplary method includes forming a rare earth hydroxide and exposing the rare earth hydroxide to a fluorine source to produce a rare earth fluoride. Another exemplary method includes fluorinating a rare earth hydroxide without use of F₂ or HF to produce a rare earth fluoride and purifying the rare earth fluoride.

This application is a continuation of co-pending U.S. patent application Ser. No. 11/228,989, filed on Sep. 16, 2005, and, also claims priority to U.S. Provisional Patent Application Ser. No. 60/610,876 filed on Sep. 17, 2004.

### BACKGROUND

The synthesis of rare earth doped compounds to create phosphors which are capable of upconversion fluorescence are described in articles such as F. E. Auzel, “Materials and Devices Using Double-Pumped Phosphors with Energy Transfer,” Proceedings of the IEEE, Vol. 61, No. 6, pp. 758-786, June 1973; and T. Kano, H. Yamamoto, and Y. Otomo, “NaLnF₄: Yb³⁺, Er³⁺ (Ln: Y, Gd, La): Efficient Green-Emitting Infrared-Excited Phosphors,” J. Electrochem Soc.: Solid State Science and Technology, pp. 1561-1564, November 1972. These syntheses rely upon the fluorination of compounds by HF (and sometimes fluorine) which is a dangerous material. Further, the fluorinations require the use of special equipment which complicates the synthesis process and makes it expensive.

### SUMMARY OF THE DESCRIPTION

Certain embodiments of this invention relate to chemical compositions for (dried) gels of rare earth doped compounds such as rare earth doped hydroxides, and a process for synthesizing them from an oxide reaction with an acid and a precipitation reaction with a base.

Certain embodiments of this invention also relate to a process for synthesizing crystalline phosphor particles from the gel using heat, a solid fluorinating agent (e.g. Na₂SiF₆), and activated charcoal.

Certain embodiments of this invention also relate to a method of washing the particles to remove residual process chemicals.

Certain embodiments of this invention also relate to a method of producing the particles in a range of small sizes.

Certain embodiments of this invention also relate to the application of the particles to substrate surfaces using carrier media and coatings.

Certain embodiments of this invention also relate to the integration of the particles into bulk media.

Certain embodiments of this invention also relate to the interrogation of the particles using fluorescence-based optical techniques. Specifically the use of upconversion to visible that is induced by exposing the material to IR wavelengths. Some of the compositions can exhibit dynamically changing colors upon exposure to varying intensities of IR excitation. At least some of the compositions of the invention may be used to label products so that the labeled products can be identified as genuine. For example, the compositions can be applied to a product (e.g. a watch or a purse or a shoe or an integrated circuit) by an authorized manufacturer of the product, and distributors (e.g. retailers) and others can verify that the product was made by an authorized manufacturer rather than a counterfeit manufacturer which seeks to pass off the counterfeit product (which is not labeled with a composition of the invention) as a genuine product.

The primary chemical composition in a typical embodiment of this invention is AB_{(1-ΣRE)}REₓC₄ where A is an element from the IA or IIA group of the periodic table, B is from groups IIA or IIIA of the periodic table, REₓ is a rare earth element, or combination thereof, from the lanthanide (atomic numbers 57-71) group of periodic table, and C₄ is from the halide (VIIB) group of elements. For example, the compositions can include NaY_{(1-Σx)}REₓF₄ or NaLa_{(1-Σx)}REₓF₄. The host composition is ABC₄, whereas the dopants are the rare earth elements. When synthesized according to the described procedure, this composition of particles yields a particle distribution, typically in the range of 500 nm to 100 um (but sometimes greater or less) and typically often in the range of 5-50 um. When co-doped with Yb as a sensitizer to increase the 980 nm absorption, the particles can be made to undergo very efficient upconversion to a variety of colors including UV and IR. Certain compositions of the basic formula can also be induced to undergo a change in emitted color when exposed to varying intensities of light excitation such as 980 nm excitation. This is seen as a change in color from red and green (yellow) to green as the focus of a 980 nm laser is moved away from a substrate coated with the material. The typical yellow color at the focus is spectrally composed of about a 50% mixture of the two emission lines, where as the green, which dominates the color spectrum when the intensity is low, emits primarily green with a substantially reduced red component.

Certain embodiments include the following novel features:
1. Certain embodiments described herein use a process for preparing fluorine containing phosphors which do not use toxic and/or corrosive fluoride starting materials or fluorinating agents, such as hydrogen fluoride; this is different than the prior art which uses toxic and/or corrosive fluoride starting materials or fluorinating agents such as HF.
2. In certain embodiments described herein, fluorination reactions can be performed in the presence of air (e.g. O₂ and other elements of the Earth's atmosphere) and/or moisture (H₂O in vapor form). For example, a fluorination reaction, which is used to synthesize a phosphor, can be performed by heating a reaction mixture (e.g. a mixture of rare earth hydroxides and Na₂SiF₆) in a platinum crucible over an open flame; such an environment for a fluorination reaction is usually considered deleterious for the reaction.
3. In certain embodiments described herein, an improved product (e.g. improved phosphor) may be obtained by performing a fluorination reaction (e.g. heating a reaction mixture of rare earth hydroxides and Na₂SiF₆) in a CO₂/CO atmosphere provided by a charcoal pack. This CO₂/CO atmosphere may have little, if any, air or moisture.
4. In certain embodiments described herein, the synthesis methods can eliminate the need for an inert atmosphere (such as an atmosphere which is substantially pure nitrogen or argon which is usually provided under flow conditions in an expensive tube furnace). In certain embodiments of the synthesis methods, any open-air oven capable of reaching the high temperatures (e.g. temperatures greater than 600° C. or 630° C.) and capable of providing the temperature changes over time (ramp time) can be used, optionally with a charcoal pack which is described herein.
5. In certain embodiments described herein, silicon tetrafluoride (SiF₄) may be used to fluorinate selected rare earth hydroxides (e.g. Y(OH)₃, Yb(OH)₃, and Er(OH)₃). The silicon tetrafluoride is generated from the thermal decomposition of Na₂SiF₆.
6. In certain embodiments described herein, the particle sizes of the final phosphor product may be controlled to be in a narrow range, wherein most (e.g. at least 90%) of the particle sizes may be in a range of 0.5 um to 100 um or may be in an even smaller range of 5 um to 50 um or may be in an even smaller size range of 0.5 um to 10 um. For example, the particle sizes of most particles may be less than 100 um, with substantial fractions in the 5 um to 50 um range and in the 0.5 um to 10 um range. In these embodiments, the disclosing process techniques allow the insitu generation of reaction pre-cursor reactants of small particle size (estimated to be less than 1 um), the growth of which can be controlled to yield a narrow distribution of particle sizes.
7. In certain embodiments, improved phosphor products may be produced by aqueous washing Na₂SiF₆, resulting in a pure-white, high quality phosphor product in these embodiments. Unwashed, commercial grade (greater than 97% pure) Na₂SiF₆ apparently has impurities which darken and degrade synthesized phosphor products.

The accompanying SOP (Standard Operating Procedures) describes certain embodiments of a process for synthesizing the material.

At least certain embodiments of the invention can produce materials that are very efficient at converting infrared light to visible light. The host composition of an exemplary embodiment is fluoride based and as such, has intrinsic low phonon energies. In addition, it enables a hexagonal crystalline structure to be created further enhancing the efficiency of the upconverted fluorescence. Additionally, very high efficiency Stokes fluorescence can also be induced in RE doped particles that are exposed to UV at the appropriate wavelength.

The composition of an exemplary embodiment has extremely high temperature stability, even in the presence of oxygen. It is also very inert to other chemicals including acids, bases, solvents, water, and air, and as such can be readily incorporated into mixtures of other chemicals such as inks, coatings, paints, polymers, glass, metals, etc. It is both color fast and light fast and will not degrade in UV, even after long periods of exposure. Particles can be made in different sizes by controlling the duration of time that the material is exposed to the process temperatures. Longer times in an oven at high temperatures will produce larger particles, wherein the distribution of the sizes will be closer to the larger sizes (e.g. 30-50 um) with longer heat treatments (e.g. in the oven described below). The particles are also relatively soft enabling them to be used with roller-based printing processes such as gravure.

Because of their high efficiency, the particles can also undergo grinding, which typically reduces brightness, and still provide high levels of induced fluorescence. This enables small particle integration applications such as ink jet printing.

The material can also be integrated onto substrates at high temperatures, such as glass and metals, while still retaining its high fluorescence efficiencies. The material can be applied to the surface (glass, for instance) while still in the wet or dry gel state, and the temperature treatment can be subsequently performed. The result is a layer of (crystalline) material, which has been fused into the surface of the substrate, which yields the upconversion properties of the particles, but which cannot be readily removed. The ability to apply the material to substrates in high temperature processes enables products such as glass perfume bottles to be made by, for instance, dropping small beads of the dried gel into the molds where it can be fused into the surfaces during the blowing/forming/casting process. This requires minimal interruption to the bottle manufacturing process, while providing a security or identification/authentication feature on the product.

The particles can also be integrated onto films, which undergo a subsequent transfer process onto other substrates and surfaces. An example of such is the integration onto thermal transfer material, which will be printed using thermal transfer printing processes or embossed using hot die stamping. The particles can be integrated into pre-impregnated rollers of ink, such as those that use wax, and subsequently applied to substrates via a hot roller printing process. The particles can be integrated directly into inks, coatings, lacquers and varnishes, polymers, etc. They can also be integrated into prepackaged delivery mechanisms such as spray paints, toners, ink cartridges, rollers, transfer films, etc.

Certain embodiments include the following novel features:
1.) particle sizes and distributions.
2.) integration of the particles onto substrates.
   labels
   thermal transfer ribbons and films
   glass
   metal (watches)
   leather (handbags, wallets, shoes, luggage)
   paper, cloth, mesh, plastic
3.) integration of the particles into delivery mechanisms
   toner cartridges
   rollers
   ink jet cartridges
   thermal transfer ribbons
   pen cartridges (felt tip, ball point, fountain, etc)
   spray paint cans
4.) printing, coating, or otherwise applying the particles onto substrate material.
   Gravure printing
   Flexographic printing
   Thermal transfer printing
   Any type of printing
   Thermal transfer/embossing film
5.) exciting the particles with IR light to produce upconverted light.
6.) exciting the particles with UV to produce Stokes fluorescence.

### BRIEF DESCRIPTION OF THE DRAWINGS

The present invention is illustrated by way of example and not limitation in the figures of the accompanying drawings in which like references indicate similar elements.

FIG. 1 is a flowchart which shows an exemplary method of preparing certain rare earth flourides.

FIG. 2 is a chemical flowchart showing chemical reactions in an exemplary implementation of a method in FIG. 1.

FIG. 3 shows an example of a charcoal pack which is used in certain operations in the method of FIG. 1.

### DETAILED DESCRIPTION

The following discussion sets out specific details about certain embodiments. It will be appreciated that alternative embodiments and implementations may use different starting materials or use different process operations or delete certain process operations or perform certain process operations in a different sequence.

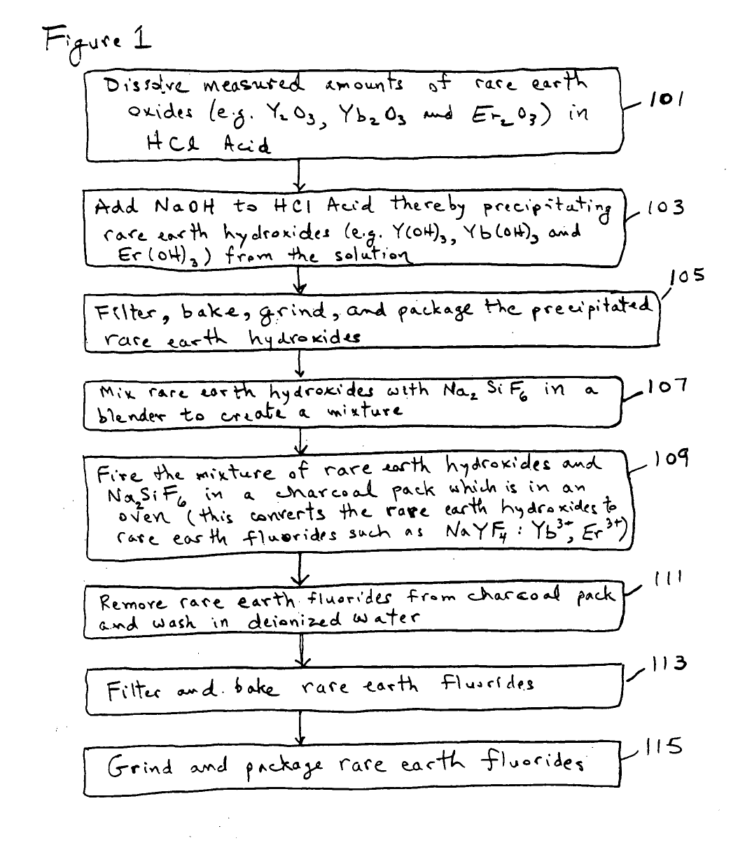

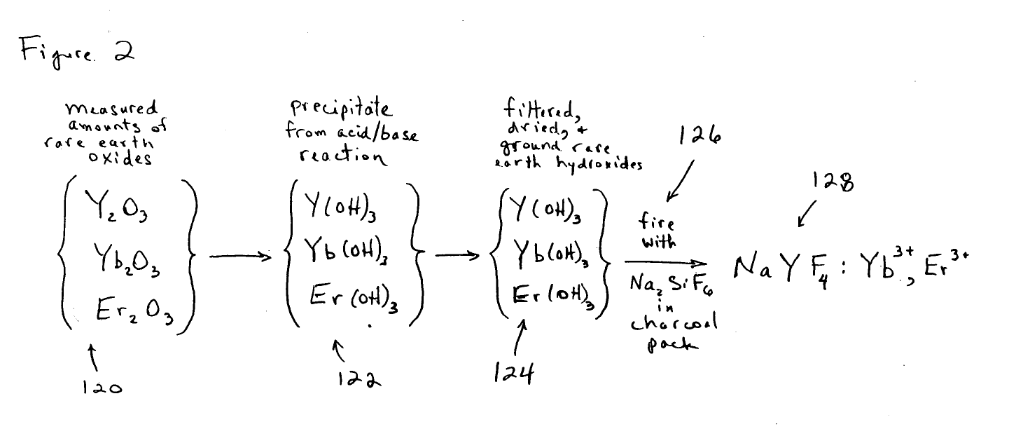

An exemplary method is shown in the flowchart which is labeled as FIG. 1. FIG. 2 is a chemical flowchart which shows the chemical reactions involved in an exemplary implementation of the method depicted in FIG. 1. The method of FIG. 1 may begin in operation 101, in which certain measured amounts of selected rare earth oxides (e.g. Y₂O₃, Yb₂O₃, and Er₂O₃) are dissolved into hydrochloric acid (HCl). In one embodiment for producing an upconverting phosphor, it is desirable to produce a final composition of NaYF₄:Yb³⁺, Er³⁺ in which the molar percentages of Y, Yb and Er are about 80%, 18% and 2% respectively. These percentages are produced in the first example represented in Table A; in this example, to make one kilogram of final product, 441.4582 grams of 99.9% pure Y₂O₃ and 173.3458 grams of 99.9% pure Yb₂O₃ and 18.6956 grams of 99.9% pure Er₂O₃ are the certain measured amounts which are dissolved into 37% HCl acid in operation 101. Continuing with this example, 1011.0027 grams of Na₂SiF₆ will be mixed with the rare earth hydroxides (derived from the rare earth oxides) in operation 107.

After the rare earth oxides are dissolved in HCl, a 6.0 molar solution of NaOH (sodium hydroxide) is added to the HCl solution. Further specific details of one exemplary implementation of operation 103 are provided below in the SOP Section 3 (“Precipitating Rare Earth Hydroxides with NaOH”). In the example represented by Table A, the precipitated rare earth hydroxides, after the HCl and NaOH neutralization reaction, are Y(OH)₃, Yb(OH)₃ and Er(OH)₃. The reaction which converts the rare earth oxides to rare earth hydroxides is shown in FIG. 2 as the change of materials 120 to materials 122 and is shown in FIG. 1 as operation 103. It will be appreciated that methods, other than the precipitation method of operation 103, may be utilized to produce rare earth hydroxides.

After the rare earth hydroxides have precipitated from operation 103, these rare earth hydroxides are then filtered, baked, ground and packaged in operation 105 of FIG. 1 to produce materials 124 of FIG. 2. Further specific details of one exemplary implementation of operation 105 are provided below in the SOP Section 4 (“Filtration, Baking, Grinding, and Packaging of Rare Earth Hydroxides”).

After the dried and ground rare earth hydroxides have been obtained from operations 103 and 105 (or from alternative operations), these rare earth hydroxides are then mixed with a source of fluorine in operation 107. In the specific exemplary implementation of operation 107 which is described in Section 5 (“Mixing Rare Earth Hydroxides with Sodium Hexafluorosilicate using the Cuisinart Blender”), the fluorine source is Na₂SiF₆. The Na₂SiF₆ starting material (e.g. commercial grade which is purer than 97% of Na₂SiF₆) may be purified before being mixed with the rare earth hydroxides. The Na₂SiF₆ starting material may be purified by stifling it with deionized water in a 4:1 (weight/weight) ratio of deionized water/solid. The mixture is allowed to settle, the supernatant decanted, and the solids filtered, washed and dried. In the first example represented in Table A, 1011.0027 grams of washed Na₂SiF₆ are mixed in operation 107 with the rare earth hydroxides obtained from operation 105. This mixing will create a mixture which is heated in operation 109 to cause a reaction to form the desired phosphor product. This heating may (optionally) be performed in a charcoal pack which is described below.

After the mixing operation 107, the mixture (of rare earth hydroxides and Na₂SiF₆) is baked (“fired”) in an oven or other heat source in operation 109. The environment of the oven or other heat source may be natural air (with a mixture of O₂, N₂ and other gases and H₂O vapor) or an inert atmosphere (e.g. an atmosphere which is substantially pure, >99%, N₂ or Ar) or an atmosphere with substantial amounts (e.g. more than 30% by weight) of CO₂/CO from a charcoal pack. The baking in the oven will convert the rare earth hydroxides to rare earth fluorides doped with rare earth ions, such as NaYF₄:Yb³⁺, Er³⁺. The heating of the Na₂SiF₆ will decompose the Na₂SiF₆ into SiF₄ (which reacts with the rare earth hydroxides to form rare earth fluorides) and NaF which reacts with the rare earth fluorides.

Table B shows two examples of the temperature and processing times for operation 109. The first example is for the “Standard Green” phosphor which does not change its fluorescing color with changes in intensity of the excitation source (which is typically an infrared (IR) source), and this first example corresponds to and is the same example as the “Standard Green” example in Table A, which lists the weights of the materials used to make about 1 kilogram of the “Standard Green” phosphor. The second example in Table B is for the yellow to green “visishift” phosphor materials (“Visishift Y-G”) which do change their fluorescencing color with changes in intensity of the excitation source (which is typically an IR source); this second example in Table B corresponds to and is the same as the second example in Table A which lists the weights of the materials used to make about 1 kilogram of the “Visishift Y-G” material (from 245.6135 g of Y₂O₃, 411.4952 grams of Yb₂O₃, 16.6427 g of Er₂O₃, and 899.9847 g of Na₂SiF₆).

In the first example of Table B (for making the “Standard Green” phosphor), the mixture of rare earth hydroxides (derived from 441.4582 g of Y₂O₃, 173.3458 g of Yb₂O₃, and 18.695 g of Er₂O₃) and the fluorine source (e.g. 1011.0027 g of Na₂SiF₆) is placed into the oven at 25° C. (optionally, the mixture is placed into a charcoal pack which is then placed into the oven at 25° C.); then, the temperature of the oven is increased (e.g. linearly increased) from 25° C. to about 600° C. over a period of about 90 minutes. After reaching 600° C. at the end of 90 minutes, the oven maintains the temperature of about 600° C. for 600 minutes, and then the oven is cooled (e.g. the temperature is linearly decreased) from 600° C. to 25° C. over a period of about 600 minutes. The product is then removed from the over for further processing. A specific exemplary implementation of operation 109 is described in Section 6 (“Firing of the Rare Earth Hydroxides in Crucible Furnace”) of the SOP. Operation 126 shown in FIG. 2 is also another example of operation 109 which ultimately produces a final product such as an upconverting phosphor material 128.

In the second example of Table B (for making the Visishift Y-G material), the mixture of rare earth hydroxides (derived from 245.6135 g of Y₂O₃, 411.4952 g of Yb₂O₃, and 16.6427 g of Er₂O₃) and the fluorine source (e.g. 899.9847 of Na₂SiF₆) is placed into the oven at 25° C. (optionally, the mixture is placed into a charcoal pack which is then placed into the oven at 25° C.). Then, the temperature of the oven is increased over a period of about 90 minutes (e.g. linearly increased) from 25° C. to about 630° C. After reaching 630° C. at the end of 90 minutes, the oven maintains the temperature of about 630° C. for 1200 minutes, and then the oven is cooled (e.g. the temperature is linearly decreased) from 630° C. to 25° C. over a period of about 600 minutes. The product (Visishift Y-G) is then removed from the oven for further processing.

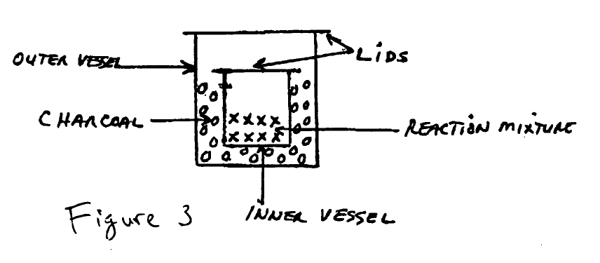

A charcoal pack is a two chamber reaction vessel that reduces the O₂ concentration in the inner vessel by placing it in a surrounding bed of charcoal (contained within the outer vessel), thereby providing a CO/CO₂ buffer atmosphere. Continuous diffusion of oxygen from the furnace atmosphere into the charcoal pack assembly is reduced by placing lids on both the outer (the charcoal container) and inner (the phosphor reaction vessel). Ambient air muffle furnaces can therefore be used for reactions that are air sensitive at high temperatures. An example of a charcoal pack is shown in FIG. 3.

After operation 109, the rare earth fluoride will be removed from the oven (and from the charcoal pack if used) and washed with deionized water in operation 111 shown in FIG. 1. A specific exemplary implementation of operation 111 is described in Section 7 (“Removing R.E. Fluorides from Crucibles and Washing in D.I. H₂O”) of the SOP.

After operation 111, the rare earth fluorides are filtered and then baked in operation 113 shown in FIG. 1. A specific exemplary implementation of operation 113 is described in Section 8 (“Filtration and Baking of Rare Earth Fluorides”) of the SOP.

After operation 113, the dried rare earth fluorides, which may be upconverting phosphors of the general formula NaYF₄:Yb³⁺, Er³⁺, are ground and packaged in operation 115 shown in FIG. 1. A specific exemplary implementation of operation 115 is described in Section 9 (“Grinding and Packaging Rare Earth Fluorides”) of the SOP.

### Standard Operating Procedure (SOP) Table of Contents

1. Weighing Rare Earth Oxides
2. Dissolving Rare Earth Oxides in Hydrochloric Acid
3. Precipitating Rare Earth Hydroxides with NaOH
4. Filtration, Baking, Grinding, And Packaging of Rare Earth Hydroxides
5. Mixing Rare Earth Hydroxides with Sodium Hexafluorosilicate using the Cuisinart Blender
6. Firing of Rare Earth Hydroxides in Crucible Furnace
7. Removing R.E. Fluorides from Crucibles and Washing in D.I. H2O.
8. Filtration and Baking of Rare Earth Fluorides
9. Grinding and Packaging Rare Earth Fluorides

Appendix:

Starting Material weights needed for Green and Visishift phosphors.

### Weighing Rare Earth Oxides

### Purpose

To accurately and precisely weigh out measured amounts of Rare Earth (R.E.) Oxides.

### Scope

This Procedure applies to all Products which utilize Rare Earth Oxides as starting materials.

### Requirements

Quantities of R.E. Oxides should be accurately weighed to within +/−0.001 g and transferred to Process Beakers.

### Supplies

Rare Earth Oxides, (R.E. Oxides),

Purity 99.9% or greater.

### Preparations

From the Desiccator in which the rare earth (R.E.) oxides are stored, obtain the required R.E. Oxides for weighing. Verify at this time that the Hygrometer on the Desiccator is reading less than 10%.

### Operation

Verify that the Balance is in the ‘Weigh’ Mode, and is reading in grams (g). Verify that the Balance is reading in the milligram (0.001 gr) range. With the Balance Chamber Doors CLOSED, verify that the Balance is reading in the ‘Stable’ Condition. Press the Tare (O/T) button, and verify that the Balance reads out 0.000 gr.

Open the Balance Chamber Doors, and place an appropriate Polystyrene Weighing Dish on the Balance Pan. Close the Chamber Doors, and allow the Reading the Stabilize. When the reading is stable, record the Tare Weight of the Dish on the Worksheet. This is recorded in case any stability issues develop on the Balance.

‘Zero’ the Balance by pressing the Tare (O/T) button. Verify that the Balance reads 0.000 g in Stabilized Mode.

Open the Balance Chamber Doors. Open the appropriate Bottle of R.E. Oxide. Using the desired Spoon, Spoonulas, and Microspatulas, transfer the required weight of the R.E. Oxide from the Bottle to the Weighing Dish.
Work carefully to ensure that no R.E. Oxide is spilled onto the Balance Pan, as this will create inaccurate readings.
It is best practice to approach the desired weight from the ‘low’ side, gradually adding material until the desired weight is obtained.
When final weights are being taken, it is required that the Balance Chamber Doors be CLOSED, and that no Metal Utensils be in the direct vicinity of the Balance. This is due to magnetic influence errors existing on the Balance.
For Production Lots, it is desirable that quantity of the R.E. Oxides be precise to within +/−0.001 gr. (1 mg).

When the correct weight of R.E. Oxide has been obtained, record the weight in the Production Laboratory Book, and, working carefully, remove the Weighing Dish from the Balance. The correct weights of the three rare earth oxides for the first example (“Standard Green”) in Table A are: 441.4582 g for Y₂O₃; 173.3458 g for Yb₂O₃; and 18.6956 g for Er₂O₃. For the second example (“Visishift Y-G”) in Table A, the correct weights of the three rare earth oxides are: 245.6135 g of Y₂O₃; 411.4952 g of Yb₂O₃ and 16.6427 g of Er₂O₃. In each example, these weights are for making about 1 kilogram of final product.

Carefully Pour the R.E. Oxide from the Weighing Dish into the 4000 ml Pyrex Beaker. Carefully folding the Weighing Dish slightly may assist in the pouring process.
To ensure complete transfer of the R.E. Oxide, very gently tap the underside of the Weighing Dish with your fingers while pouring it into the Beaker, and verify visually when completed that all of the R.E. Oxide has been transferred into the Beaker.

For certain Formulas, it may be required that the quantity of the R.E. Oxide being weighed be divided into two parts. If this occurs, weigh out the first half of the R.E. Oxide, and record this in the Lab Book. Then transfer the R.E. Oxide in the Weighing Dish to the Beaker, re-weigh and Tare the Weighing Dish. After this, weigh out the second half of the material, and transfer it to the Beaker.

When the R.E. Oxide has been transferred to the Beaker, cover the beaker with the Watch Glass. Re-Seal the R.E. Oxide Bottle, and return the Bottle to the Desiccator.

Discard the Weighing Dish into the trash. Do NOT reuse Weighing Dishes, as this can cause inaccurate weights and contamination of the R.E. Oxide materials.

Repeat these operations for the remaining R.E. Oxides to be Weighed. Record the Tare Weights and Material Weights carefully in the Lab Book, in order to preserve material traceability.

When all Weighings have been completed, cover the Beaker with the Watch Glass, and transfer to the Fume Hood.

### Dissolving Rare Earth Oxides in Hydrochloric Acid

### Purpose

To completely dissolve Rare Earth (R.E.) Oxides in Hydrochloric Acid, converting them to soluble Rare Earth Ions.

### Scope

This Procedure applies to all Products which utilize Rare Earth Oxides as starting materials.

### Requirements

Quantities of Hydrochloric Acid should be measured to +/−5 ml., and used to dissolve mixtures of Rare Earth Oxides under controlled conditions.

### Supplies

Hydrochloric Acid, (HCl), 37%, Reagent Grade

### Equipment

Thermolyne ‘ Mirak’ Magnetic Stirring Hot Plate

Fume Hood with Chemical Exhaust

Polyethylene Containment Tray, Nalgene or equivalent material

### Preparations

Place a layer of doubled Paper Towels on the working surface of the Fume Hood. These are used to provide a clean working environment as well as serve to absorb any spills that might occur. Place the Polyethylene Containment Tray on the Paper Towels

Place the Hot Plate in the Containment Tray. Verify that the Front Sliding Glass Door will completely close. Verify that both the Fume Hood Illumination and Fume Hood Exhaust Fan are functioning

Plug the Hot Plate into the Outlet on the front surface of the Fume Hood. Verify that the Hot Plate is Turned OFF, and that the Stir Motor is turned OFF.

Prepare Hot Plate by carefully cleaning the surface of the Hot Plate with a moist Paper Towel. If there are significant deposits of ‘baked on’ material, use a moistened Scotch Brite pad. Dry the Hot Plate with a clean, dry Paper Towel.

### Operation

Place the 4000 ml Beaker containing the mixture of R.E. Oxides on the Hot Plate. Using a Teflon Stir rod, carefully stir the mixture until it is a uniform composition. Wash any residual R.E. Oxides from the Stir Rod with D.I. Water from the Wash Bottle.

Place a 3″ Teflon Stir Bar in the Beaker containing the R.E. Oxides. Place the 1 L Graduated Cylinder and a bottle of Hydrochloric Acid, 37 in the Fume Hood. Turn on the Exhaust Fan.

Carefully transfer 900 ml of Hydrochloric Acid, 37%, from the HCl bottle to the 1 L Graduated Cylinder.

Remove the Watch Glass from the top of the 4000 ml. Beaker containing the Rare Earth Oxides. SLOWLY and CAREFULLY begin pouring the Hydrochloric Acid into the Beaker.
CAUTION ! The reaction between the Hydrochloric Acid and the R.E. Oxides is VERY Exothermic. The reaction will be accompanied by copious fuming and bubbling of the mixture. Do NOT allow the mixture to come into contact with Eyes or Skin. Do NOT breathe the Fumes.

Continue adding the HCl until appx. 400 ml have been added. At this point, stop the pouring, and allow the reaction to begin to subside. Place the Watch Glass back onto the Beaker.
The reaction should not be allowed to completely stop at this stage. If the reaction stops completely, the mixture will harden into a ‘cake-like’ consistency that will be difficult to dissolve.

When the reaction has subsided slightly, remove the Watch Glass from the Beaker and resume pouring the HCl slowly into the Beaker. Continue pouring until the remaining 500 ml of HCl is in the Beaker. Place the Watch Glass back onto the Beaker. Allow the reaction to begin to subside.

Transfer another 900 ml of HCl to the Graduated Cylinder.

Remove the Watch Glass from the top of the Beaker containing the R.E. Oxide/Acid Mixture. Continue pouring the Hydrochloric Acid into the Beaker until another 450 ml of HCl has been added. Place the Watch Glass back onto the Beaker. Allow the reaction to begin to subside.

When the reaction has subsided slightly, remove the Watch Glass from the Beaker and resume pouring the HCl slowly into the Beaker. Continue pouring until the remaining 450 ml of HCl is in the Beaker. Place the Watch Glass back onto the Beaker. Allow the reaction to begin to subside.

Turn on the Stir Motor. It is unlikely that the stir bar will be free to move at this particular time, but as the reaction progresses movement should begin. If the stir bar has not begun to spin after 30 min., try to free it with a Teflon stir rod.

Turn on the Hot Plate. Set the Temperature with the Temperature Control Dial to 160 C.
A Setting of 160 C on the Hotplate Controller will result in a Hot Plate Surface Temperature of appx. 180 C and a Solution Temperature of appx 75 C after 4 hours.

Continue to monitor the solution, verifying that the solution does not begin to boil. If the solution appears to be getting too hot, reduce the Hot Plate temperature setting to less than 100 C.

The R.E. Oxides will take between 1 and 2 hours to completely dissolve in the HCl Solution. Continue to monitor the solution during this period. When the Solution is completely free of un-dissolved material, turn off the Hot Plate, and continue to allow the solution to Stir at appx. 150 RPM. When cool enough to safely move, remove the beaker from the hotplate.

If the solution must be left standing overnight, continue to stir the solution at appx. 150 RPM to prevent re-crystallization of the R.E. Chlorides from the solution. Keep the Fume Hood closed, and the Exhaust Fan ON. Leave the Fume Hood Light ON.

### Precipitating rare earth hydroxides with NaOH

### Purpose

To precipitate Rare Earth (R.E.) Hydroxides from Solution by the use of Sodium Hydroxide

### Scope

This Procedure applies to all Products which utilize Rare Earth Oxides as starting materials.

### Requirements

Quantities of 6.0 M Sodium Hydroxide should be measured to +/−5 ml, and used to precipitate mixtures of Rare Earth Hydroxides from solution.

### Supplies

6.0 M Sodium Hydroxide (NaOH) Solution

Polyethylene Wash Bottle, D.I. Water

### Equipment

Fume Hood with Chemical Exhaust

Overhead Stir Motor, Barnant Mixer Series 10, or equivalent, with Screw Attachment Clamp and Teflon Stir Paddle

pH test strips measuring a range of at least 6-14 pH.

### Preparations

Place a layer of doubled Paper Towels on the working surface of the Fume Hood. These are used to provide a clean working environment as well as serve to absorb any spills that might occur.

Place the Laboratory Support Stand in the Fume Hood. Verify that the Front Sliding Glass Door will completely close. Verify that both the Fume Hood Illumination and Fume Hood Exhaust Fan are functioning

Place a layer of paper Towels on the flat surface of the Laboratory Support Stand.

Using the Screw Clamp, attach the Overhead Stir Motor to the Vertical Shaft of the Laboratory Support Stand. Adjust the height of the Motor so that a 4000 ml Beaker can be placed underneath it with the Teflon Stir Paddle in position.

Using the Chuck Key, insert the Teflon Stir Paddle into the chuck of the Overhead Stir Motor. Carefully tighten the Chuck with the Chuck Key. Verify that the Teflon Stir Paddle is held in the Chuck securely.

Obtain a 4000 ml Pyrex Beaker, 200 mm Watch Glass, a 1.0 L Graduated Cylinder, and a 100 ml Graduated Cylinder. Verify that the glassware is clean and free from contamination. Place these in the Fume Hood.

Verify that there is at least 4000 ml of 6.0 M Sodium Hydroxide (NaOH) solution. Place this in the Fume Hood.

### Operation

Transfer half of the Solution of Rare Earth (R.E.) Chlorides from the 4000 ml Beaker into the second 4000 ml Beaker. When complete, there should be two equal portions of appx 1000 ml each of the solution in the two Beakers. Cover both Beakers with the 200 mm Watch Glasses.

Place one of the Beakers of R.E. Chloride Solution on the Laboratory Support Stand. Remove the Watch Glass.

Loosen the Clamp holding the Overhead Stirring Motor, and lower the Motor until the tip of the Teflon Stirring Paddle is within 10 mm of the bottom of the Beaker. Tighten the clamp, and plug in the power cord for the Motor. Verify the operation of the Motor by starting it at low speed. Use the Speed Control Knob on the Motor to adjust the stirring speed.

Transfer 1.0 L of 6.0 M NaOH from the NaOH bottle to the 1.0 L Graduate Cylinder.

With the Overhead Stir Motor Running, carefully and slowly pour the liter of NaOH into the Beaker containing the R.E. Chloride Solution. The solution will begin turning a milky white color, and floating clumps of white material will appear. If the Teflon Stir Paddle begins to slow down, carefully increase the stirring speed to ensure it continues to turn. Do not increase the speed so much that splashing of the solution occurs.
CAUTION ! The reaction between Sodium Hydroxide (NaOH) and Hydrochloric Acid (HCl) is VERY Exothermic. The reaction may be accompanied by copious fuming and bubbling of the mixture. Do NOT allow the mixture to come into contact with Eyes or Skin. Do NOT breathe the Fumes.

Transfer 500 ml of 6.0 M NaOH from the NaOH bottle to the 1.0 L Graduate Cylinder.

Add the second 500 ml of NaOH to the Beaker. Monitor the Teflon Stir Paddle, and adjust the speed as necessary to ensure stirring without splashing of solution.

Using the Teflon Stir Rod, gently stir up the mixture around the edges of the Beaker to ensure complete mixing. It may be necessary to move the Beaker around on the Laboratory Support Stand to complete the mixing process. Allow the mixture to stir for 2-3 minutes.

Use the pH test strip to measure the basicity of the mix.
If the pH of the mixture is less than 12.0, transfer 50 ml. of 6.0 M NaOH into the 100 ml. Graduated Cylinder. Verify that the bottom of the meniscus is even with the 50 ml. mark on the Cylinder. Carefully pour the 50 ml. of NaOH into the mixture. Allow the mixture to continue to stir for 2-3 minutes.
Repeat the pH measurement as in previous operations, and, if necessary, continue to adjust the mixture with 6.0 M NaOH in 50 ml. increments, as in previous operations, until the pH is greater than 12.0.

When the pH of the mixture has been correctly adjusted, continue to stir the mixture under moderate speed until it is a uniform, milky white, high viscosity liquid. At that point, turn off the Stir Motor.

Loosen the Clamp on the Overhead Stir Motor, and raise the Motor to the top of the Laboratory Support Stand Rod. Use the D.I. Water Squeeze Bottle to carefully wash the excess precipitate from the Teflon Stir Paddle into the 4000 ml Beaker. Cover the Beaker with a 200 mm Watch Glass, and place the Beaker aside in the Fume Hood.

Repeat the operations with the second 4000 ml Beaker of R.E. Chloride Solution. When both Beakers are completed, they are ready for Filtration.

### Filtration, Baking, Grinding, and Packaging of Rare Earth Hydroxides

### Purpose

To Separate by Filtration, Dry, Grind, and Package Rare Earth (R.E.) Hydroxide Mixtures.

### Scope

This Procedure applies to all Products which utilize Rare Earth Oxides as starting materials.

### Requirements

Quantities of R.E. Hydroxides should be Filtered, Dried, Ground, and Packaged under conditions designed to ensure purity of the finished product.

### Supplies

Two 4000 ml Beakers, Pyrex or Equivalent Material

Two 200 mm Watch Glass

Stir Rod, Glass

Polyethylene Wash Bottle, D.I. Water

Polyethylene Wash Bottle, Acetone

Paper Towels

Schleicher and Schuell MicroScience 24 cm. Sharkskin Filter Disks, 8-12 um porosity

23.5 cm coarse plastic mesh disk

1.0 Kg. Polyethylene Wide-Mouth bottles, Nalgene or

Equivalent

N95 Particulate respirator

Polypropylene burst shield

### Equipment

Buchner Funnel, 253 mm, Coors Type, or Equivalent, with Neoprene

Adapter Sleeve

4000 ml. Erlenmeyer Side Arm Flask

Laboratory Support Stand, Vertical Rod Type

Fisher Hastalloy Support Clamp with Rod Clamp.

Barnant Vacuum/Pressure Pump, Model #400-1901, with Norton ‘MasterFlex’ Hose.

Memmert/Wisconsin Oven Stainless Steel Drying Oven

Pyrex Drying Dishes, 400×270 mm

Paint Scrapers, various.

Large Stainless Steel Spatula

Fisherbrand Spoonula, Fisher #14-375-10

### Preparations

Place a layer of doubled Paper Towels on the working surface of the Laboratory Bench

Place the Laboratory Support Stand on the Bench.

Place a layer of paper Towels on the flat surface of the Laboratory Support Stand.

Using the Screw Clamp, attach the Fisher Hastalloy Support Clamp to the Laboratory Support Stand. Adjust the height of the Support Clamp so that it will surround the neck of the 4000 ml. Erlenmeyer Side Arm Flask

Place the 4000 ml. Erlenmeyer flask on the Laboratory Support Stand. Adjust the Support Clamp so that it grips the neck of the flask firmly. Surround flask with burst shield in case of flask failure under vacuum.

Attach the Barnant Vacuum/Pressure Pump with the Norton MasterFlex Hose to the Side Arm of the Erlenmeyer Flask. Plug in the Pump briefly to verify that it is pulling a vacuum.

Turn on the Memmert/Wisconsin Oven Stainless Steel Drying Oven. Verify that the Temperature is set at 130 C.

Verify that all Glassware and other Equipment is clean and free from chemical or other contamination.

### Operation

Section 1—Filtration

Place the Buchner Funnel into the neck of the Erlenmeyer Flask using the Rubber Vacuum Sleeve to provide a positive seal.

Moisten the Plastic Mesh disk with D.I. H2O, and center it in the Buchner Funnel.

Place a 24 cm. Sharkskin Filter Disk in the Buchner Funnel over the plastic mesh. Verify that it is centered, and completely covers the plastic mesh. Moisten the Sharkskin Filter Disk with D.I. H₂₀, and carefully smooth out any wrinkles. Briefly apply a vacuum to completely smooth out the Filters.

Transfer a 4000 ml. Beaker of Rare Earth (R.E.) Hydroxide Precipitate Material from the Fume Hood to the Filtration Area.

Plug in the Vacuum Pump. When the pump has established a good vacuum in the Erlenmeyer, remove the Watch Glass from the Beaker, and begin slowly pouring the R.E. HydroxidePrecipitate Material into the Buchner Funnel. A Glass Stir rod may be used if desired to more carefully control the pouring of the liquid.
The D.I. Water Polyethylene Wash Bottle should be used to wash any residual material from the Beaker into the Buchner Funnel. Work carefully so as to both avoid losing material and avoid using too much water to wash the Beaker clean. This is a critical operation, and should be performed very carefully to ensure that no Precipitate material is lost.

Filter the Material until it appears a solid mass. Monitor the Filtrate, and wash it twice with 500 mL D.I H2O, allowing the filtrate to become a solid mass after each wash. Do not allow the Filtrate to begin to ‘crack’ on the filter, as this will inhibit the effectiveness of the washing.

Unplug the Vacuum Pump, and remove the burst shield and vacuum hose from the side of the Erlenmeyer Flask.

Using the Stainless Steel Spatula, separate the edges of the filtrate material from the Buchner Funnel. Transfer any filtrate material that sticks to the Spatula to the Pyrex Drying Dishes.

Carefully remove the Buchner Funnel from the Erlenmeyer Flask. Invert the Funnel over the Pyrex Drying Dish, and tap the Funnel gently to cause the filtrate material to drop from the Funnel into the Dish. This is a critical operation, and should be performed very carefully to ensure that no filtrate material is lost.

Using the Stainless Steel Spatula and the Spoonula, carefully scrape any residual filtrate material from the inside of the Buchner Funnel and transfer it to the Pyrex Drying Dish. This is a critical operation, and should be performed very carefully to ensure that no filtrate material is lost.

When all of the filtrate material has been removed from the Buchner Funnel, transfer the funnel and the plastic mesh Filter Disk to the Lab sink and wash both items thoroughly with D.I. H2O. Remove the Erlenmeyer Flask from the Clamp, and dispose of wash water. Rinse the Erlenmeyer Flask with D.I. H2O, and return it to the Laboratory Support Stand.

Carefully remove and set aside the plastic mesh disk from the Filtrate material in the Pyrex Baking Dish. This will be cleaned and re-used.

Carefully remove and discard the Sharkskin Filter Disk.

Using the Stainless Steel Spatula and the Spoonula, carefully break up the mass of the Filtrate Material and distribute it around the interior of the Pyrex Baking Dish. Work very carefully to ensure that no filtrate material is lost.

Place the 4000 ml. Erlenmeyer flask on the Laboratory Support Stand. Adjust the Support Clamp so that it grips the neck of the flask firmly. Replace the burst shield.

Attach the Barnant Vacuum/Pressure Pump with the Norton MasterFlex Hose to the Side Arm of the Erlenmeyer Flask. Plug in the Pump briefly to verify that it is pulling a vacuum.

Repeat these operations on the second Beaker of R.E. Hydroxide Precipitates.

Section 2—Drying

When both halves of the Rare Earth Hydroxides have been Filtered and placed in the Pyrex Drying Dishes, place both dishes into the Memmert/Wisconsin Oven Stainless Steel Drying Oven. Verify that the Oven Temperature is set at 130 C.

The R.E. Hydroxide Filtrate Material will typically be allowed to dry overnight.

When the Filtrate Material has been completely dried, it should be a uniform pink or off-white. Remove the two Drying Dishes from the Oven, and, place them on the Laboratory Bench to cool.

Section 3—Grinding

As the two Drying Dishes cool, use the Stainless Steel Spatula, the Spoonula, and the Paint Scrapers to carefully scrape the Dried Filtrate Material from the Drying Dishes.

Using the Stainless Steel Spatula, the Spoonula, and the Paint Scrapers, break the chunks of Dried Filtrate Material into a coarse powder. Work carefully to ensure that the material is not scattered or contaminated. When completed, the R.E. Hydroxide Material should be a uniform, coarse powder.

Section 4—Packaging

When the grinding operation is completed, transfer the R.E. Hydroxide Material into 1.0 L Polyethylene Wide-Mouth Bottles using the various Stainless Steel Spoons and the Spoonulas.

Label the Bottles with appropriate information, including Lot or Batch Number, R.E. Hydroxide composition, presence or amount of Sodium HexaFluoro Silicate, Firing State.

### Mixing Rare Earth Hydroxides with Sodium Hexafluorosilicate Using the Cuisinart Blender

### Purpose

To accurately and precisely weigh out measured amounts of Rare Earth Hydroxides and Sodium HexaFluoroSilicate and mix them using the Cuisinart Blender

### Scope

This Procedure applies to all Products which utilize Rare Earth Oxides as starting materials.

### Requirements

Quantities of R.E. Hydroxide Mixtures and Sodium HexaFluoroSilicate shall be accurately measured out and mixed using the Cuisinart Blender.

### Supplies

N95 Particulate respirator

Fisherbrand Spoonula, Fisher #14-375-10

Fisherbrand Microspatula, Fisher #21-401-10

Stainless Steel Spoons, various sizes

1000 ml Beakers, Pyrex or Equivalent Material

125 mm Watch Glasses

Kim-Wipe Tissues

Paper Towels

1.0 Kg Polyethylene Wide-Mouth Bottles, Nalgene or Equivalent.

Sodium HexaFluoroSilicate, 99.9% Purity, ARC-WC-2-54, or Equivalent.

### Equipment

Fume Hood with Chemical Exhaust

Cuisinart Blender, SmartPower Premier, Model #CBT 500/CBT 500C

Ohaus Voyager Series Balance, 0.1 gr. resolution.

### Preparations

Place a layer of doubled Paper Towels on the working surface of the Fume Hood. These are used to provide a clean working environment as well as serve to absorb any spills that might occur.

Assemble and set up the Cuisinart Blender in the Fume Hood. Plug the Blender into the electrical outlet on the Fume Hood and verify the operation of the Blender in Pulse, Slow, and High Speeds. Verify that the Blender Bowl is clean, dry, and free from contamination.

Prepare Balance area by carefully cleaning Laboratory Bench with moist Kim-Wipes to remove any trace of residual chemicals from previous operations.

From the roll of Paper Towels, tear off 2-4 towels, and fold them so that a double thickness is produced. Place this on the Balance Table to serve as a clean work surface.

Verify that the Balance is turned OFF. Carefully wipe the area on and around the Balance platform with a dry Kim Wipe to remove any residual chemicals from previous operations.

Turn the balance back ON. Verify that the Balance is reading in ‘Grams’ scale.
If the Balance is not reading in the ‘Grams’, use the ‘Scroll’ and ‘Enter’ keys to select the Main Menu, and configure the Balance to the ‘Grams’ scale. When finished, exit the Main Menu, and verify that the Balance is reading 0.0 gr when in the ‘Stable’ mode. If the Balance is not reading 0.0 gr, use the ‘Tare’ (O/T) key to ‘zero’ the Balance.

Obtain the required Rare Earth (R.E.) Hydroxide Mixture and Sodium HexaFluoroSilicate from the appropriate Storage locations. Verify that the identity of the Materials is correct as per the labels on the Bottles.

Obtain the required formulas and weights for the R.E. Hydroxide and Sodium HexaFluoroSilicate to be used in the Process. Record in the production lab book the required information, including materials to be used and theoretical weights.

### Operation

Place a clean, dry 1000 ml Pyrex Beaker on the Ohaus Balance. Record the weight of the Beaker on the Worksheet.

‘Zero’ the Balance using the Tare (O/T) button.

From the Bottle of R.E. Hydroxide Mixture, using the Stainless Steel Spoons and Spoonulas transfer about 220 g of R.E. Hydroxide to the Beaker. Record the weight of R.E. Hydroxide in the Lab Book.

Pour the contents into the blender.

Place a clean, dry 1000 ml Pyrex Beaker on the Ohaus Balance. Record the weight of the Beaker on the Worksheet.

‘Zero’ the Balance using the Tare (O/T) button.

From the Bottle of Sodium HexaFluoroSilicate, using the Stainless Steel Spoons and Spoonulas, transfer the required amount of Sodium HexaFluoroSilicate to the Beaker. Record the weight of Sodium HexaFluoroSilicate in the Lab Book.

Pour the contents into the blender

Replace the Lid on the Blender, and, holding the Lid and Bowl down on the Blender with one hand, start the Blender on HIGH Speed with the other hand. This is to ensure that the Bowl and Lid to not separate or come off the Blender.

Holding the Base of the Blender with one hand and the Lid and Bowl with the other, ‘angle’ the Blender at appx 45-60 degrees to the Fume Hood Work Surface. Begin to slowly rotate the Blender, to thoroughly mix the contents.

Mix the Materials for a minimum of 1.0 minute. When completed, shut down the Blender and allow the Materials to settle in the Blender Bowl. (Tap the top of the blender to assist in the settling.)

Transfer the Mixture to a 1.0 L Polyethylene Wide-Mouth Bottle.

Repeat these operations until sufficient Material has been prepared for the Production Operation.

### Firing of Rare Earth Hydroxides in Crucible Furnace (Large Crucible C-Pack Method)

### Purpose

To perform the high temperature firing of Rare Earth Hydroxides into Rare Earth Fluorides, using the Large Crucible C-Pack Method.

### Scope

This Procedure applies to all Products which utilize Rare Earth Oxides as starting materials.

### Requirements

To Accurately Weigh Precise amounts of R.E. Hydroxide/Sodium HexaFluoroSilicate Mixture and Fire it in the Vcella Kiln for prescribed times and at prescribed temperatures (see Table B for two examples of prescribed times and temperatures).

### Supplies

N95 Dust Mask

Fisherbrand Spoonula, Fisher #14-375-10

Fisherbrand Microspatula, Fisher #21-401-10

Stainless Steel Spoons, various sizes

1000 ml Beakers, Pyrex or Equivalent Material

125 mm Watch Glasses

Kim-Wipe Tissues

Paper Towels

‘Dust-Off’ Aerosol, or equivalent

FiberFrax ‘Millboard’ 25 mm thick Thermal insulation material, cut into 135 mm Disks

Quartz Cylinder, 210 mm×135 mm

Coors Alumina Disc, 152 mm, Coors #65639

Coors Alumina Disc, 102 mm, Coors #65637

Coors Alumina Crucible, Cylindrical, 93×167 mm, Coors #65546

Charcoal, Activated, Lab Pro # C 2790

Polyethylene Cylinder Funnel,

1″ Fine Bristle Paint Brush

### Equipment

Vcella High Temperature Furnace

Love/Dwyer Model 16A Temperature Process Controller

Ohaus ‘Voyager’ Series Balance

VWR Aquasonic 750 HT Ultrasonic Cleaner.

### Preparations

Place a layer of doubled Paper Towels on the working surfaces of the Laboratory Bench and the Fume Hood.

Prepare Balance area by carefully cleaning Laboratory Bench with moist Kim-Wipes to remove any trace of residual chemicals from previous operations.

Verify that the Balance is turned OFF. Carefully wipe the area on and around the Balance platform with a dry Kim Wipe to remove any residual chemicals from previous operations.

Turn the balance back ON. Verify that the Balance is reading in ‘Grams’ scale.
If the Balance is not reading in the ‘Grams’, use the ‘Scroll’ and ‘Enter’ keys to select the Main Menu, and configure the Balance to the ‘Grams’ scale. When finished, exit the Main Menu, and verify that the Balance is reading 0.0 gr when in the ‘Stable’ mode. If the Balance is not reading 0.0 gr, use the ‘Tare’ (O/T) key to ‘zero’ the Balance.

Obtain the required Rare Earth (R.E.) Hydroxide/Sodium HexaFluoroSilicate Mixture from the appropriate Storage location. Verify that the identity of the Material is correct as per the labels on the Bottles.

Verify that all Glassware, Crucibles, and Equipment is clean, dry, and free from chemical or other contamination.

### Operation

Section 1—Charging of Crucibles for Firing

Determine the total weight of the R.E. Hydroxide/Sodium HexaFluoroSilicate Mixture, either from the labels on the Bottles, or from by weighing the material on the Ohaus Balance.
If the Material must be weighed, perform the operation in a clean, 2000 ml beaker, and work carefully to avoid contaminating the material.

Determine the number of Crucibles to be Fired. The Maximum Loading of a Crucible is about 800 grams of Material. If the total quantity of material to be fired is not an even multiple of 800 grams, divide the total weight by the number to crucibles to be used in order to evenly divide the weight among all the crucibles.

Verify that the Crucibles are legibly labeled with an I.D. Letter. If a Crucible is not labeled, label it with a graphite pencil on the side, bottom, and on the Alumina Disk which is to serve as the Crucible Lid. Also at this time label the 150 mm Alumina Disks which are to serve as the Quartz Cylinder Lids. Use the same I.D. Letter to designate both the Crucible and the Quartz Cylinder it will be fired in.

Place a clean, dry Alumina Crucible on the Ohaus Balance. Record the weight of the empty crucible in the Laboratory Production Notebook Tare the Crucible by pressing the (O/T) Button on the Balance.
CAUTION: The Following Step requires extreme care and caution. The Alumina Crucibles are extremely fragile, and EXPENSIVE! Under NO circumstances use any implement to ‘pry’ against the side or bottom of the Crucible

Using Stainless Steel Spoons, Spoonulas, and Microspatulas, carefully transfer the required amount of R.E. Hydroxide/Sodium HexaFluoroSilicate Mixture from the Storage Bottle to the Crucible. Work carefully to ensure that the Material is not contaminated.

When the required amount of material has been placed in the Crucible, record the total weight of the Material in the Laboratory Production Notebook. Gently pack the powder inside the crucible by softly striking the bottom of the crucible with your hand.

Remove the Crucible from the Balance and place the appropriate 102 mm Alumina Lid on the Crucible. Verify that the Letter I.D. on the Lid matches the Crucible. Place the Charged Crucible aside in the Fume Hood.

Repeat these operations for the remaining Crucibles to be prepared.

Section 2—Preparing of C-Pack Cylinders for Firing

Remove the Lid from the Quartz C-pack Cylinder. Verify that the Letter I.D. on the Lid Matches the Letter I.D. of the Crucible to be placed into the Cylinder.
CAUTION: The FiberFrax Millboard Disks used as bottoms for the Quartz Cylinders are NOT attached to the Cylinders. Handle the Cylinders carefully, using your fingers to ensure that the bottoms do not fall out, either before or after a Crucible is placed within a Cylinder.

Carefully place the Crucible into the Quartz Cylinder. Center the Crucible in the Quartz Cylinder without disturbing the crucible Cap.

Place the Polyethylene Cylinder Funnel over the top of the Quartz Cylinder.

Using the Stainless Steel Spoons and Spoonulas, carefully begin filling the space between the outside of the Alumina Crucible and the inside of the Quartz Cylinder with Activated Charcoal. Use the funnel to channel the charcoal into the desired space.
Work very carefully to avoid getting Charcoal into the Alumina Crucible. This step is very crucial to avoid contamination of the R.E. Hydroxide/Sodium HexaFluoroSilicate Mixture with Charcoal dust.

Fill the Quartz Cylinder with Fresh Charcoal until the level of the Charcoal is within 10 mm of the bottom of the Crucible Cap.
It may be desirable to lightly ‘tamp down’ the Charcoal, to ensure that it is level around the Cylinder.
It may be useful at this step to employ the Fine Bristled Paint Brush to brush off any excess Charcoal Dust from the top of the crucible cap. It is also advisable to take a damp paper towel and clean off the charcoal dust from the crucible lid.

Open the Crucible to ensure that there are no traces of Charcoal Dust. If Charcoal Dust is present in the crucible, carefully scrape out the charcoal with a spatula

Carefully place a 102 mm Coors Alumina Disc on the top of the Crucible. Make certain that the ‘clean’ side is facing down towards the R.E. Hydroxide/Sodium HexaFluoroSilicate Mixture.

Carefully place the 152 mm Coors Alumina Disk onto the top of the Quartz Cylinder. This completes the Cylinder Loading operation for this Cylinder.

Place the Completed Cylinder aside. Repeat these operations for the remainder of the Crucible/Cylinder combinations to be prepared.

Section 3—Preparation and Loading of Vcella High Temperature Furnace

Carefully transfer the loaded Crucible/Cylinder combinations to the Vcella High Temperature Furnace.
CAUTION: The FiberFrax Millboard Disks used as bottoms for the Quartz Cylinders are NOT attached to the Cylinders. Handle the Cylinders carefully, using your fingers to ensure that the bottoms do not fall out, either before or after a Crucible is placed within a Cylinder.

Place the Crucible/Cylinder combinations in the Furnace, arranging them as per the diagram, ‘Large Crucible Oven Layout’ Move the Cylinders carefully in the oven to avoid scraping the floor of the Furnace.

Close and Latch the Furnace Door. Verify that the Latch is securely closed.

Unplug the Main Power Cord for the Vcella High Temperature Furnace from the wall socket. Examine the Love/Dwyer Temperature Controller and verify that the proper heating program has been entered. Make any necessary adjustments. Once the program is set, turn off the controller box and plug the furnace power cord back into the Wall Socket.

Turn on the Power Switch on the Controller Box. The Love/Dwyer Controller will go through the Self Test, and will then begin the High Temperature Process (see Table B for two examples of high temperature processes).

Section 4—Unloading Vcella High Temperature Furnace

When the Furnace has completed the process and has cooled sufficiently to allow the Crucible/Cylinders to be handled, carefully unload the Furnace.

Transport the Crucible/Cylinders to the Lab for further processing.

### Removing R.E. Fluorides from Crucibles and Washing in D.I. H20

### Purpose

To remove Rare Earth (R.E.) Fluorides from C-Pack Crucibles and wash in D.I. H2O.

### Scope

This Procedure applies to all Products which utilize Rare Earth Oxides as starting materials.

### Requirements

Quantities of Fired Rare Earth (R.E.) Fluorides shall be removed from Alumina Crucibles, accurately weighed, and washed in D.I. H2O.

### Supplies

N95 particulate mask

Fisherbrand Spoonula, Fisher #14-375-10

Fisherbrand Microspatula, Fisher #21-401-10

Stainless Steel Spoons, various sizes

Crucible Tongs, Fisher #15-193 or Equivalent

10 L Beaker, Pyrex or Equivalent Material

Mortar and Pestle, Large

Kim-Wipe Tissues

Paper Towels

### Equipment

Fume Hood with Chemical Exhaust

Overhead Stir Motor, Barnant Mixer Series 10, or equivalent, with Screw Attachment Clamp and Teflon Stir Paddle

Ohaus Voyager Series Balance, 0.1 gr. resolution.

### Preparations

Place a layer of doubled Paper Towels on the working surface of the Fume Hood. These are used to provide a clean working environment as well as serve to absorb any spills that might occur.

Prepare Balance area by carefully cleaning Laboratory Bench with moist Kim-Wipes to remove any trace of residual chemicals from previous operations.

From the roll of Paper Towels, tear off 2-4 towels, and fold them so that a double thickness is produced. Place this on the Balance Table to serve as a clean work surface.

Verify that the Balance is turned OFF. Carefully wipe the area on and around the Balance platform with a dry Kim Wipe to remove any residual chemicals from previous operations.

Turn the balance back ON. Verify that the Balance is reading in ‘Grams’ scale.
If the Balance is not reading in the ‘Grams’, use the ‘Scroll’ and ‘Enter’ keys to select the Main Menu, and configure the Balance to the ‘Grams’ scale. When finished, exit the Main Menu, and verify that the Balance is reading 0.0 gr when in the ‘Stable’ mode. If the Balance is not reading 0.0 gr, use the ‘Tare’ (O/T) key to ‘zero’ the Balance.

### Operation

Place a clean, dry 10 L Pyrex Beaker in the fume hood. Lower stir motor with Teflon paddle so the paddle is about a centimeter from the bottom.

Fill the beaker with 10 L. of de-ionized water. Begin stirring, adjusting the stir speed to form a strong vortex in the water, but preventing any splashing from the paddle.

Remove an Alumina Crucible with the Fired R.E. Fluorides from the C-Pack Quartz Tubes. Note in the Production Laboratory Notebook the identification of the Crucible and its weight.

Working carefully to ensure that charcoal from the C-Pack does not get into the Crucible, use a moist paper towel to brush off all of the excess Charcoal Dust and contamination from the Lid and the outside of the Crucible. When the outside of the Crucible is clean, remove the lid.

Using the Microspatula, the Spoonula, and the Stainless Steel Spatula, carefully remove the Fired R.E. Fluoride Material from the Crucible to the mortar bowl. Usually the bottom of the crucible can be gently patted with the base of the hand to loosen the bulk of the material into the mortar.

Using the Spoonula and the Stainless Steel Spatula, carefully scrape all the residual traces of the R.E. Fluoride Material from the Crucible. Transfer all of the material to mortar.

When all of the R.E. Fluoride Material has been transferred, grind the fluoride to a coarse powder.

Transfer powder to the blender. Tilt and grind powder more finely for at least a minute, changing the tilting angle and direction during that time.

Transfer powder to 10 L beaker.

Repeat these operations for the remaining Crucibles.

When all of the Crucibles have been processed as per these operations, allow stirring to continue for another 40 Min.

Stop the stirring and allow for the particulate to settle.

Siphon off about 8 liters of wash water. Replace with a fresh 8 L, and stir for another 30 minutes.

Stop the stirring and allow the particulate to settle. Siphon off supernatant (about 8 liters of wash water).

The Material is ready for filtration.

### Filtration and Baking of Rare Earth Fluorides

### Purpose

To Filter and Dry Rare Earth (R.E.) Fluorides.

### Scope

This Procedure applies to all Products which utilize Rare Earth Oxides as starting materials.

### Requirements

Quantities of Fired Rare Earth (R.E.) Fluorides shall be Filtered and Dehydration Baked.

### Supplies

4000 ml Beakers, Pyrex or Equivalent Material

200 mm Watch Glass

Stir Rod, Glass

Polyethylene Wash Bottle, D.I. Water

Polyethylene Wash Bottle, Acetone

Paper Towels

Kim-Wipes

Shark skin Qualitative Filter Disks, 24 cm., #10347519

N95 Particulate respirator

Polypropylene burst shield

### Equipment

Buchner Funnel, 253 mm, Coors Type, or Equivalent, with Neoprene Adapter Sleeve

4000 ml. Erlenmeyer Side Arm Flask

Laboratory Support Stand, Vertical Rod Type

Fisher Hastalloy Support Clamp with Rod Clamp.

Barnant Vacuum/Pressure Pump, Model #400-1901,

with Norton ‘MasterFlex’ Hose.

Memmert/Wisconsin Oven Stainless Steel Drying Oven

Pyrex Drying Dishes, 400×270 mm

Paint Scrapers, various.

Large Stainless Steel Spatula

Fisherbrand Spoonula, Fisher #14-375-10

Plastic mesh screen, 23.5 cm diameter circle

### Preparations

Place a layer of doubled Paper Towels on the working surface of the Laboratory Bench

Place the Laboratory Support Stand on the Bench behind the Splinter Screen

Place a layer of paper Towels on the flat surface of the Laboratory Support Stand.

Using the Screw Clamp, attach the Fisher Hastalloy Support Clamp to the Laboratory Support Stand. Adjust the height of the Support Clamp so that it will surround the neck of the 4000 ml. Erlenmeyer Side Arm Flask.

Place the 4000 ml. Erlenmeyer flask on the Laboratory Support Stand. Adjust the Support Clamp so that it grips the neck of the flask firmly. Surround flask with burst shield in case of flask failure under vacuum.

Attach the Barnant Vacuum/Pressure Pump with the Norton MasterFlex Hose to the Side Arm of the Erlenmeyer Flask. Plug in the Pump briefly to verify that it is pulling a vacuum.

Turn on the Memmert/Wisconsin Oven Stainless Steel Drying Oven. Verify that the Temperature is set at 130 C.

Verify that all Glassware and other Equipment is clean free from chemical or other contamination.

### Operation

Section 1—Filtration

Place the Buchner Funnel into the neck of the Erlenmeyer Flask using the Rubber Vacuum Sleeve to provide a positive seal.

Place Plastic Mesh, followed by Filter Disk into Buchner Funnel. Moisten the Filter Disk with D.I. H20, and carefully smooth out any wrinkles. Briefly apply a vacuum to completely smooth out the Filter.

Transfer the 10 L Beaker of Rare Earth (R.E.) Fluoride Precipitate Material from the Fume Hood to the Filtration Area.

Plug in the Vacuum Pump. When the pump has established a good vacuum in the Erlenmeyer, remove the Watch Glass from the Beaker, and begin slowly pouring the R.E. Fluoride Precipitate Material into the Buchner Funnel. A Glass Stir rod may be used if desired to more carefully control the pouring of the liquid.
The D.I. Water Polyethylene Wash Bottle should be used to wash any residual material from the Beaker into the Buchner Funnel. Work carefully so as to both avoid losing material and avoid using too much water to wash the Beaker clean. This is a critical operation, and should be performed very carefully to ensure that no Precipitate material is lost.

Filter the Material for appx. 15 min.

Unplug the Vacuum Pump, and remove the burst shield and vacuum hose from the side of the Erlenmeyer Flask.

Using the Stainless Steel Spatula, separate the edges of the filtrate material from the Buchner Funnel. Transfer any filtrate material that sticks to the Spatula to the Pyrex Drying Dishes.

Carefully remove the Buchner Funnel from the Erlenmeyer Flask. Invert the Funnel over the Pyrex Drying Dish, and tap the Funnel gently to cause the filtrate material to drop from the Funnel into the Dish. This is a critical operation, and should be performed very carefully to ensure that no filtrate material is lost.

Using the Stainless Steel Spatula and the Spoonula, carefully scrape any residual filtrate material from the inside of the Buchner Funnel and transfer it to the Pyrex Drying Dish. This is a critical operation, and should be performed very carefully to ensure that no filtrate material is lost.

When all of the filtrate material has been removed from the Buchner Funnel, transfer the funnel to the Lab sink and wash thoroughly with D.I. H2O. Remove the Erlenmeyer Flask from the Clamp, and dispose of wash water. Rinse the Erlenmeyer Flask with D.I. H2O, and return it to the Laboratory Support Stand.

Carefully remove the Plastic Mesh and Filter Disk from the Filtrate Material. Discard the Filter Disk and clean and save the Plastic Mesh disk.

Using the Stainless Steel Spatula and the Spoonula, carefully break up the mass of the Filtrate Material and distribute it around the interior of the Pyrex Baking Dish. Work very carefully to ensure that no filtrate material is lost.

Place the 4000 ml. Erlenmeyer flask on the Laboratory Support Stand. Adjust the Support Clamp so that it grips the neck of the flask firmly.

Section 2—Drying

When the Rare Earth Fluorides have been Filtered and placed in the Pyrex Drying Dishes, place both dishes into the Memmert/Wisconsin Oven Stainless Steel Drying Oven. Verify that the Oven Temperature is set at 130 C.

The R.E. Fluoride Filtrate Material will typically be allowed to dry overnight.

When the Filtrate Material has been completely dried, it should be a uniform off-white, or pink color. Remove the two Drying Dishes from the Oven, and, place them on the Laboratory Bench to cool.

As the two Drying Dishes cool, use the Stainless Steel Spatula, Spoonula, and the Paint Scrapers to carefully scrape the Dried Filtrate Material from the Drying Dishes.

Using the Stainless Steel Spatula, the Spoonula, and the Paint Scrapers, break the chunks of Dried Filtrate Material into a coarse powder. Work carefully to ensure that the material is not scattered or contaminated. When completed, the R.E. Fluoride Material should be a uniform, coarse powder.

Transfer the R.E. Fluoride Material to a clean, dry 4000 ml Beaker, and cover with a Watch Glass.

The Material is now ready for further Processing.

### Grinding and Packaging Rare Earth Fluorides

### Purpose

To Grind Rare Earth (R.E.) Fluorides using the Cuisinart Blender and Package.

### Scope

This Procedure applies to all Products which utilize Rare Earth Oxides as starting materials.

### Requirements

Quantities of Fired Rare Earth (R.E.) Fluorides shall be Ground in the Cuisinart Blender and Packaged.

### Supplies

N95 Particulate respirator

Fisherbrand Spoonula, Fisher #14-375-10

Fisherbrand Microspatula, Fisher #21-401-10

Stainless Steel Spoons, various sizes

1000 ml Beakers, Pyrex or Equivalent Material

2000 ml Beakers, Pyrex or Equivalent Material

125 mm Watch Glasses

150 mm Watch Glasses

Kim-Wipe Tissues

Paper Towels

‘Dust-Off’ Aerosol, or equivalent

Firing Process Worksheet

1.0 Kg Polyethylene Wide-Mouth Bottles, Nalgene or Equivalent.

### Equipment

Fume Hood with Chemical Exhaust

Cuisinart Blender, SmartPower Premier, Model #CBT 500/CBT 500C

Ohaus Voyager Series Balance, 0.1 gr. resolution.

205 micron mesh sieve

### Preparations

Place a layer of doubled Paper Towels on the working surface of the Fume Hood. These are used to provide a clean working environment as well as serve to absorb any spills that might occur.

Assemble and set up the Cuisinart Blender in the Fume Hood. Plug the Blender into the electrical outlet on the Fume Hood and verify the operation of the Blender in Pulse, Slow, and High Speeds. Verify that the Blender Bowl is clean, dry, and free from contamination.

Prepare Balance area by carefully cleaning Laboratory Bench with moist Kim-Wipes to remove any trace of residual chemicals from previous operations.

From the roll of Paper Towels, tear off 2-4 towels, and fold them so that a double thickness is produced. Place this on the Balance Table to serve as a clean work surface.

Verify that the Balance is turned OFF. Carefully wipe the area on and around the Balance platform with a dry Kim Wipe to remove any residual chemicals from previous operations.

Turn the balance back ON. Verify that the Balance is reading in ‘Grams’ scale.
If the Balance is not reading in the ‘Grams’, use the ‘Scroll’ and ‘Enter’ keys to select the Main Menu, and configure the Balance to the ‘Grams’ scale. When finished, exit the Main Menu, and verify that the Balance is reading 0.0 gr when in the ‘Stable’ mode. If the Balance is not reading 0.0 gr, use the ‘Tare’ (O/T) key to ‘zero’ the Balance.

Obtain the required Rare Earth (R.E.) Fluoride Material. Verify that the identity of the Materials is correct.

### Operation

Remove the Lid from the Cuisinart Blender. Remove the Watch Glasses from the Beaker of R.E. Fluoride Material.

From the Beaker of R.E. Fluoride Material, using the Stainless Steel Spoons and Spoonulas, transfer appx. 500 gr. of R.E. Fluoride Material to the Cuisinart Blender. It may be necessary to take a pestle and crush the fluoride into small chunks before putting it into the blender.

Replace the Lid on the Blender, and, holding the Lid and Bowl down on the Blender with one hand, start the Blender on HIGH Speed with the other hand. This is to ensure that the Bowl and Lid to not separate or come off the Blender.

Holding the Base of the Blender with one hand and the Lid and Bowl with the other, ‘angle’ the Blender at appx 45-60 degrees to the Fume Hood Work Surface. Begin to slowly rotate the Blender, to thoroughly mix the contents.

Mix the Materials for a minimum of 1.0 minute. When completed, shut down the Blender and allow the Materials to settle in the Blender Bowl

Tap the top to knock of powder collected and remove from Blender, and transfer the R.E. Fluoride Powder to a Clean, Dry 2000 ml Beaker. Place a Watch Glass over the Beaker, and place it aside.

Repeat these operations until all of the R.E. Fluoride Material has been ground to a fine, free-flowing powder.

Using the Tare (O/T) key ‘Zero’ the Ohaus ‘Voyager’ Balance, and place a Clean, dry 1.0 L Polyethylene Wide-Mouth Bottle on the Balance pan. Record the Weight of the Bottle on the Firing Process Sheet. Then, use the (O/T) key ‘Zero’ the Balance.

Using Stainless Steel Spoons and Spoonulas, Transfer 1000 gr of R.E. Fluoride Powder to the 1.0 L Polyethylene Wide-Mouth Bottle. Seal the Bottle. Label the Bottle with appropriate information, including Lot or Batch Number, R.E. Fluoride composition, and weight of R.E. Fluoride Powder.

Repeat these operations until all of the R.E. Fluoride Powder has been transferred to the correctly labeled 1.0 L Polyethylene Wide-Mouth Bottle. Transfer the Bottles to the appropriate Storage Area.

Depending on the desired use of the R.E. Fluoride, sifting of the powder may be required to remove any large agglomerates from the mix. Usually, sifting through the 205 micron Mesh Sieve results in a soft, usable powder. Other mesh sizes may be needed, depending on the desired results.

TABLE A
Starting material weights for green and yellow to green
visishift materials to make one kilogram of final product.
Weight amounts for Green and Visishift taggants

| Compound | Emission | Formula Weight | Y2O3 | Yb2O3 | Er2O3 | Na2SiF6 |
|---|---|---|---|---|---|---|
| Standard Green | G | 204.6038 | 441.4582 | 173.3458 | 18.6956 | 1011.0027 |
| Visishift Y-G | Y-G | 229.8428 | 245.6135 | 411.4952 | 16.6427 | 899.9847 |

Weight in Grams
Firing parameters

TABLE B

| Compound | Ramp time | Temperature | Hold time | Temperature | Ramp time | Temperature |
|---|---|---|---|---|---|---|
| Standard Green | 90 m | 600 | 600 m | 600 | 600 m | 25 |
| Visishift Y-G | 90 m | 630 | 1200 m | 630 | 600 m | 25 |

(temperature in C. °; time in minutes)

What is claimed is:

1. A method of synthesizing a phosphor which is capable of upconversion fluorescence, the method comprising:
forming a rare earth hydroxide;
exposing the rare earth hydroxide to a fluorine source to produce a rare earth fluoride, wherein at least a part of the exposing is performed under a temperature between 200-630° C.

2. A method as in claim 1 wherein the rare earth hydroxide is formed by precipitating the rare earth hydroxide in an acid base neutralization and wherein the rare earth fluoride comprises sodium.

3. A method as in claim 1 wherein a plurality of rare earth hydroxides are formed and exposed to the fluorine source and wherein the fluorine source comprises at least one of a fluorosilicate and SiF₄ and wherein the production of rare earth fluoride occurs in an atmosphere containing more than 30% by weight of CO₂/CO.

4. A method as in claim 3 wherein the atmosphere is not inert.

5. A method as in claim 3 wherein the plurality of rare earth hydroxides comprise at least Y(OH)₃, Yb(OH)₃ and Er(OH)₃.

6. A method as in claim 5 wherein F₂ or HF is not used in the process of synthesizing the phosphor which includes the rare earth fluoride.

7. A method as in claim 6 wherein the exposing is performed in the atmosphere.

8. A method as in claim 7 wherein particle sizes of the rare earth fluoride are in a range of about 5 to 50 um (micron).

9. A method as in claim 8 wherein the phosphor is: NaYF₄: Yb³⁺, Er³⁺.

10. A method of synthesizing a phosphor which is capable of upconversion fluorescence, the method comprising:
fluorinating a rare earth hydroxide without use of F₂ or HF to produce a rare earth fluoride, wherein at least a part of the fluorinating is performed under a temperature between 200-630° C.;
purifying the rare earth fluoride.

11. A method as in claim 10 wherein the fluorinating occurs in an atmosphere containing at least 5% (by weight) of O₂.

12. A method as in claim 11 wherein the atmosphere contains at least 5% (by weight) of H₂O vapor.

13. A method as in claim 10 wherein the fluorinating occurs in an atmosphere comprising at least one of CO₂ and CO provided by heated charcoal.

14. A method as in claim 11 wherein the molar percent ratio of Y, Yb, and Er in the rare earth fluoride is about 80%, about 18% and about 2% respectively.

15. A method as in claim 11 wherein the fluorinating comprises exposing the rare earth hydroxides to SiF₄.

16. A method as in claim 15 wherein the SiF₄ is generated from thermal decomposition of Na₂SiF₆.
